(19) United States
(12) Patent Application Publication
(10) Pub. No.: US 2011/0037554 A1
(43) Pub. Date: Feb. 17, 2011

(54) Vertical Double Deck Transformer for Power Supply

(76) Inventors: Tsung-Yen Tsai, Taipei County (TW); Kao-Chuan Liu, Taipei County (TW)

Correspondence Address: SHOU - HSIN YIN, P.O. BOX 90-3 Taipei, TAIPEI City, 10699, TW

(21) Appl. No.: 12/697,381

(22) Filed: Feb. 1, 2010

(30) Foreign Application Priority Data
Aug. 12, 2009 (TW) 098222918

(51) Int. Cl. H01F 27/30

(52) U.S. Cl. 336/196; 336/208; 336/220

(57) ABSTRACT

The transformer includes a bobbin and a core set. The bobbin is composed of a first winding frame and a second winding frame. A first winding area and a second winding area are defined in the first and second winding frame, respectively. Both sides of the bobbin are provided with two adapter plates. A divider wall is disposed between the two winding areas. A through hole is provided in the bobbin. The core set is composed of two half cores. A central portion of the core set penetrates the through hole. Two lateral portions encompass the bobbin and adapter plates.

### BACKGROUND OF THE INVENTION

1. Technical Field

The invention generally relates to transformers, particularly to power transformers used in power supplies.

2. Related Art

Personal computers need high quality power supplies to perform well. For computers, a power supply is an important device.

A typical transformer employed in a conventional power supply, as shown in FIGS. 1-3, is of a horizontal overlapping type. Such a transformer usually adopts two corresponding cores 11, 12 which can be combined together. The combined cores 11, 12 are separately located at the top and bottom of a bobbin 15. Two windings 13, 14 are horizontally overlapped in a winding area 16 of the bobbin 15.

In the above transformer 10, although the effect of inductive coupling of the windings 13, 14 is better, its leakage inductance is too low to satisfy the requirement of a resonant circuit. To solve this problem, an additional oscillating inductor 17 will be needed in a device using such a transformer 10. Referring to FIG. 3, the oscillating inductor 17 is associated with the capacitor 18 to form an LLC resonant circuit. The oscillating inductor 17 will cause cost increase and occupy a considerable volume on a circuit board. Thus the oscillating inductor 17 will make other components laid on the circuit board more crowded. Further, the crowded components are not only difficult to be installed on the circuit board but also disadvantageous to heat dissipation. This may result in low yield rate and shortened durability. On the other side, the secondary winding 14 winds around the primary winding 13 and the two windings 13, 14 are made of enameled wires, so the heat from the inner primary winding 13 can not be dissipated well. This will cause a temperature-rising effect, which can adversely affect the durability and performance of the transformer.

### SUMMARY OF THE INVENTION

A primary object of the invention is to provide a transformer which can reduce an occupied area on a circuit board to raise the efficiency of space utilization.

Another object of the invention is to provide a transformer which can improve heat dissipation of the windings of transformer.

To accomplish the above objects, the transformer according to the invention includes a bobbin and a core set. The bobbin is composed of a first winding frame and a second winding frame. A first winding area and a second winding area are defined in the first and second winding frame, respectively. Both sides of the bobbin are provided with two adapter plates. A divider wall is disposed between the two winding areas. A through hole is provided in the bobbin. The core set is composed of two half cores. A central portion of the core set penetrates the through hole. Two lateral portions encompass the bobbin and adapter plates.

### BRIEF DESCRIPTION OF THE DRAWINGS

FIG. 1 shows a conventional bobbin of transformer;

FIG. 2 is a cross-sectional view of the conventional bobbin of FIG. 1;

FIG. 3 shows a schematic diagram of a resonant circuit using the conventional transformer;

FIG. 4 is an exploded view of the bobbin of the invention;

FIG. 5 is a perspective view of the bobbin of the invention;

FIG. 6 is a perspective view of the bobbin with the windings;

FIG. 7 is a side view of FIG. 6;

FIG. 8 is a cross-sectional view of FIG. 7;

FIG. 9 is a cross-sectional view of FIG. 7 with another view angle; and

FIG. 10 shows a schematic diagram of a resonant circuit using the transformer of the invention.

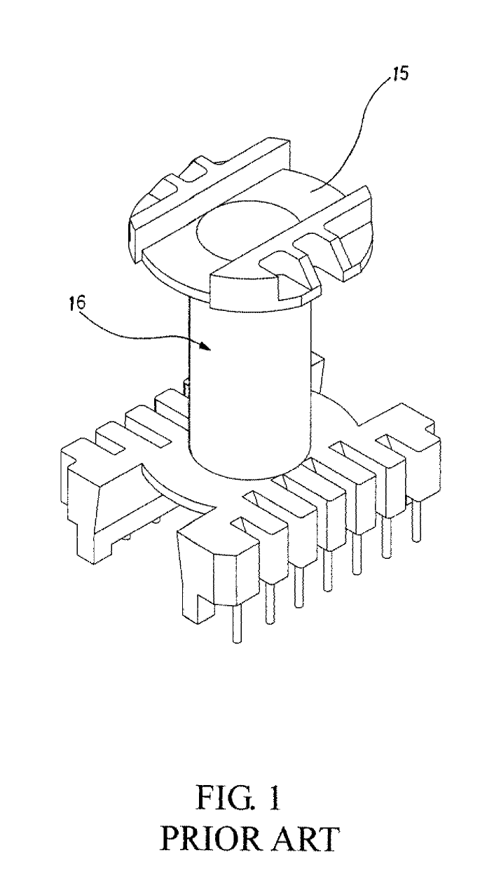

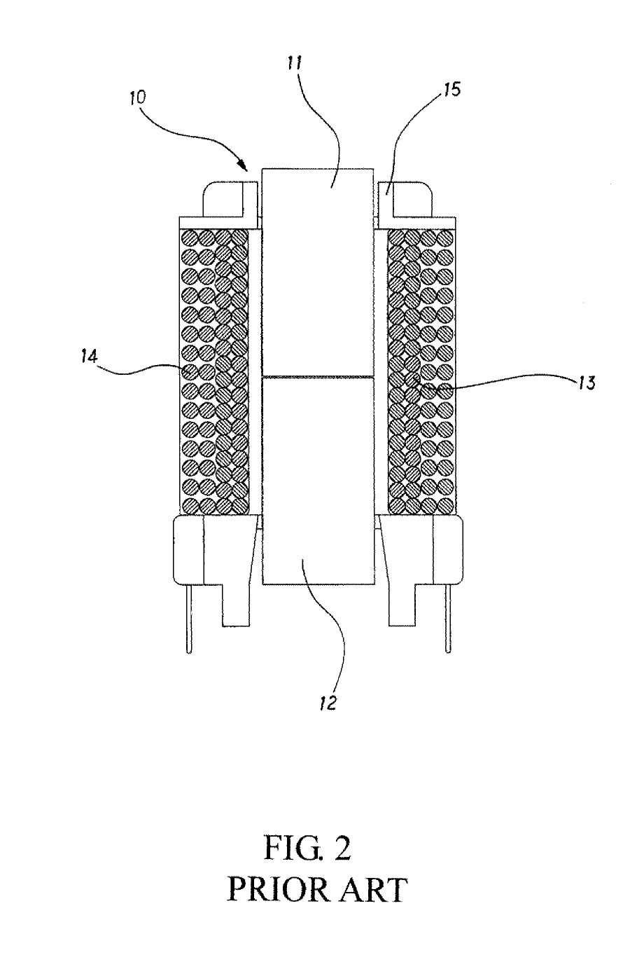

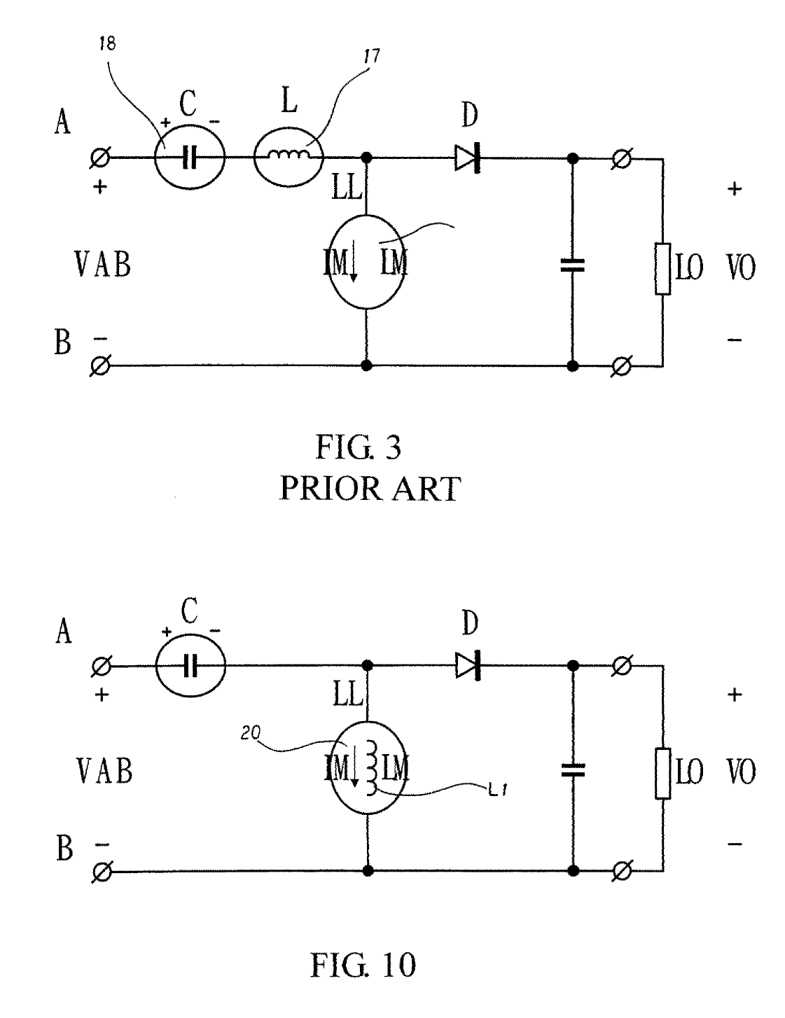

### DETAILED DESCRIPTION OF THE INVENTION

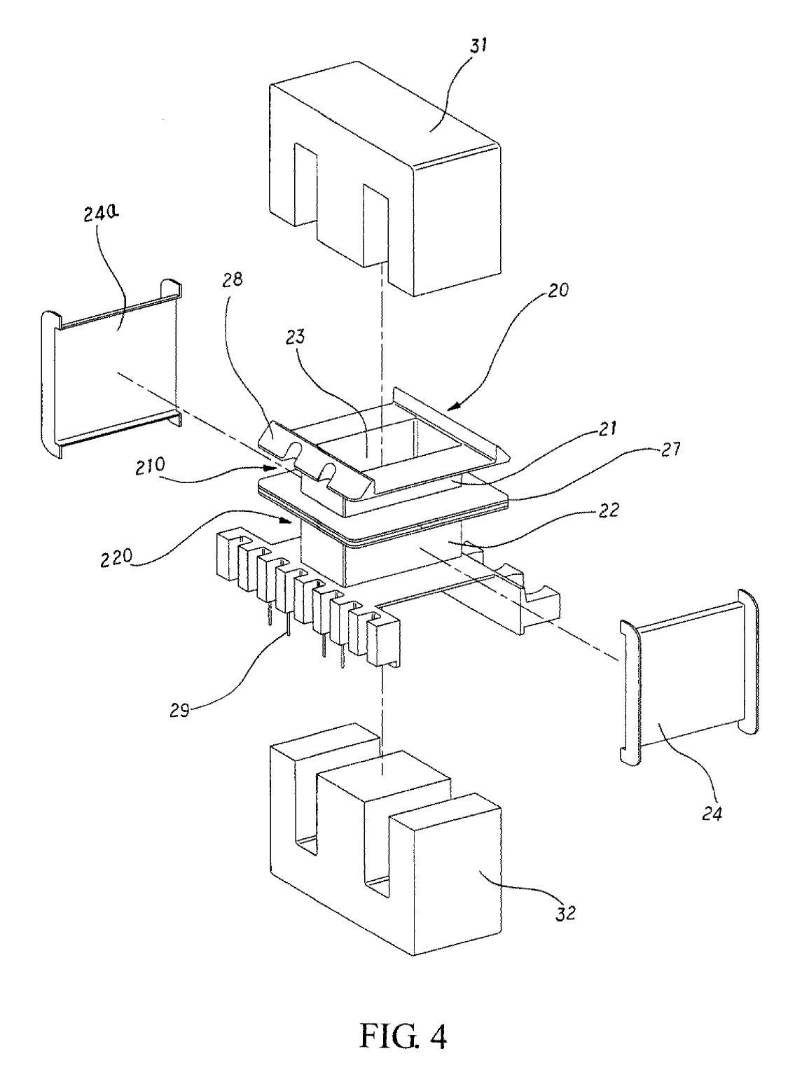

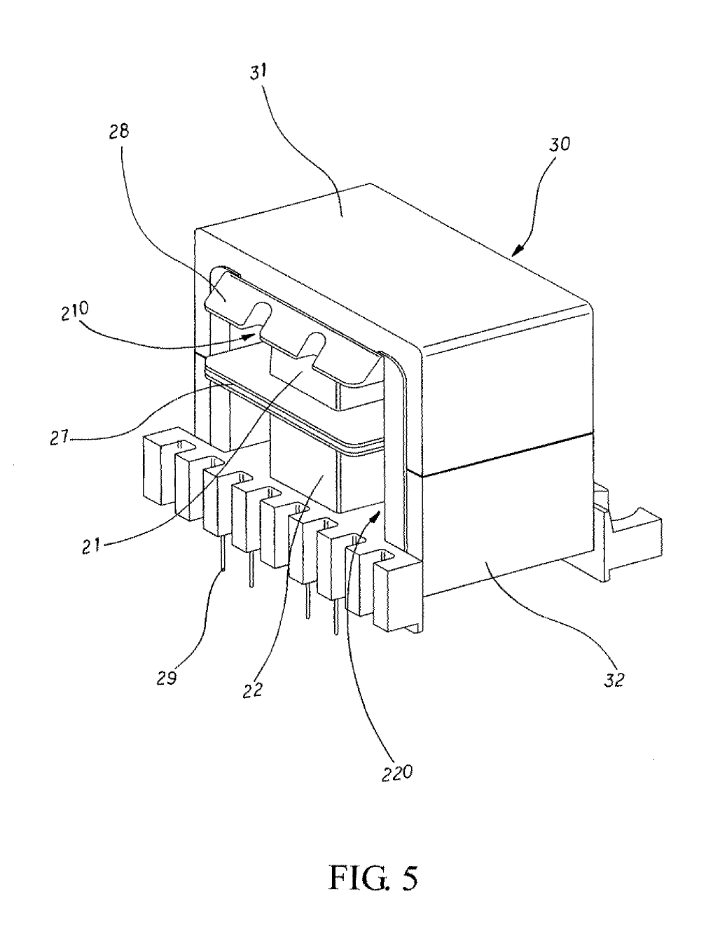

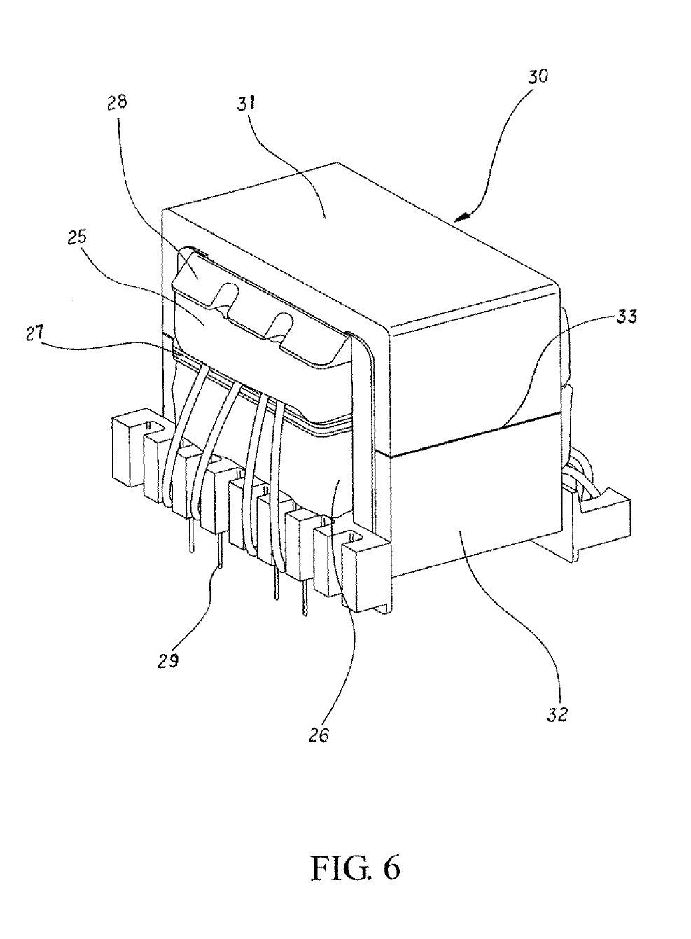

Referring to FIGS. 4-6, the transformer of the invention includes a bobbin 20 and a core set 30. The bobbin 20 is an isolator made of plastic. The bobbin 20 is composed of a first winding frame 21 and a second winding frame 22, which are longitudinally aligned. A first winding area 210 and a second winding area 220 are defined in the first and second winding frame 21, 22, respectively. A primary winding 25 and a secondary winding 26 are accommodated in the first and second winding area 210, 220, respectively. Both sides of the bobbin 20 are separately provided with two adapter plates 24, 24a. A divider wall 27 is disposed between the two winding areas 210, 220. Both top sides of the bobbin 20 extend two slopes 28 for securing the primary winding 25. A through hole 23 is longitudinally provided in the bobbin 20.

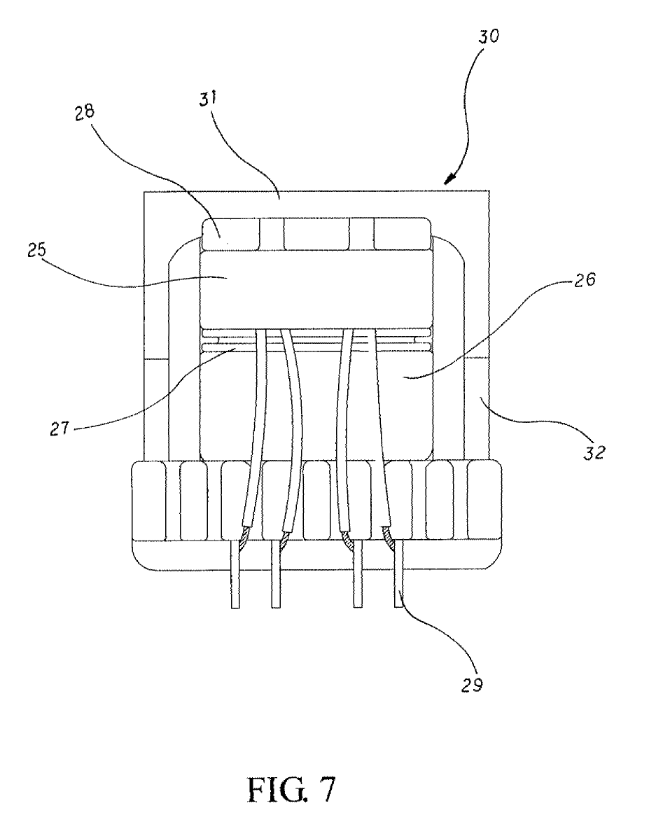

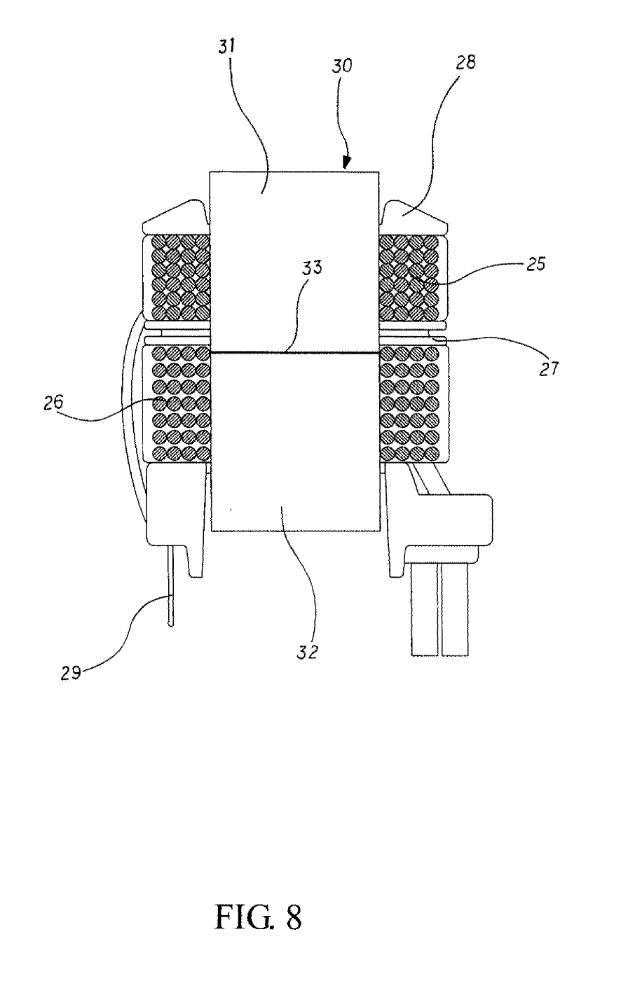

One bottom side of the bobbin 20 is provided with pins 29 for connecting a circuit board (not shown). The core set made of ferrite is composed of a first core 31 and a second core 32. The core set 30 is assembled with the bobbin 20 with inserting a central portion into the through hole 23. Both lateral portions of the core set 30 encompass the bobbin 20 and adapter plates 24, 24a as shown in FIGS. 7 and 8.

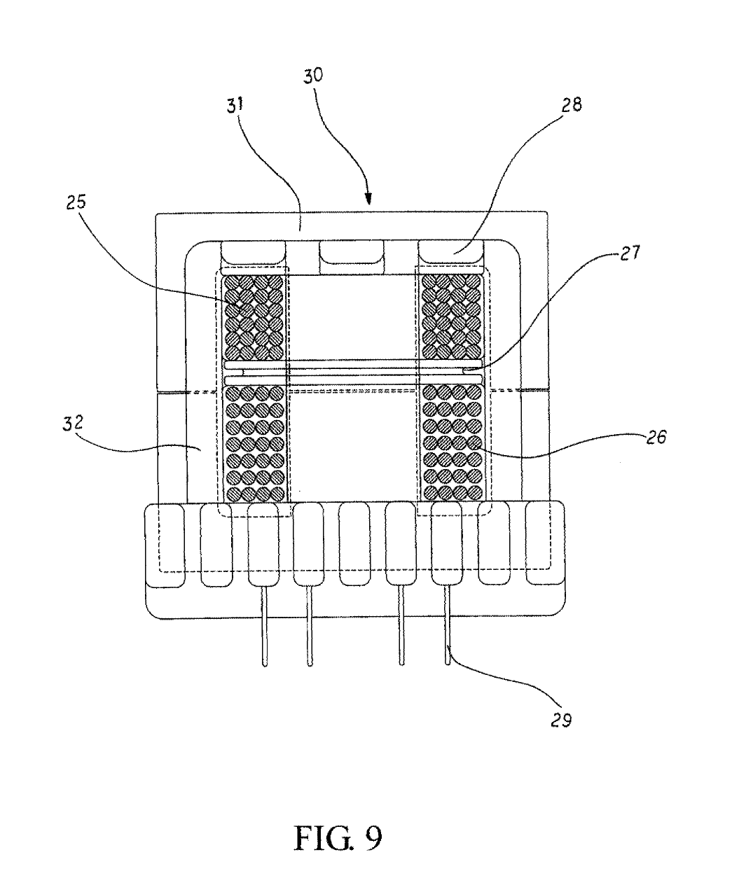

Referring to FIG. 9, the two half cores 31, 32 of the core set 30 are preferredly of an E shape. An insulating glue is applied at the junction between the cores 31, 32 for combination. However, other shapes can be applied in the two cores 31, 32 such as E-shape matching I-shape or T-shape matching U-shape.

Referring to FIG. 10, an oscillating winding L1 can be preferredly disposed at the primary winding 25 or the secondary winding 26. The oscillating winding L1 forms an oscillating inductor resonant circuit. In comparison with conventional transformers, it can save a space for disposing an oscillating winding L1 to improve the efficiency of space utilization and heat dissipation.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. A transformer for a power supply comprising:
a bobbin composed of a first winding frame and a second winding frame, which are longitudinally aligned, wherein a first winding area and a second winding area are defined in the first and second winding frame, respectively, both sides of the bobbin are separately provided with two adapter plates, a divider wall is disposed between the two winding areas, and a through hole is longitudinally provided in the bobbin; and
a core set comprising a first core and a second core, assembled with the bobbin with inserting a central portion into the through hole and both lateral portions of the core set encompassing the bobbin and adapter plates.

2. The transformer of claim 1, wherein a primary winding and a secondary winding are accommodated in the first and second winding area, respectively.

3. The transformer of claim 1, wherein the first core and the second core are of an E shape.

4. The transformer of claim 1, wherein the first core is of an I shape and the second core is of an E shape.

5. The transformer of claim 1, wherein the first core is of an E shape and the second core is of an I shape.

6. The transformer of claim 1, wherein the first core is of a U shape and the second core is of a T shape.

7. The transformer of claim 1, wherein the first core is of a T shape and the second core is of a U shape.

8. The transformer of claim 1, wherein one bottom side of the bobbin is provided with pins for connecting a circuit board.

9. The transformer of claim 1, wherein an oscillating winding is disposed at the primary winding or the secondary winding for forming an oscillating inductor resonant circuit.

10. The transformer of claim 1, wherein both top sides of the bobbin extend two slopes for securing the primary winding.

11. The transformer of claim 1, wherein the bobbin is made of plastic.

12. The transformer of claim 1, wherein the core set is made of ferrite.
